(19) United States
(12) Patent Application Publication
(10) Pub. No.: US 2016/0189455 A1
(43) Pub. Date: Jun. 30, 2016

(54) SYSTEM AND METHOD FOR MANAGING ACCESS FOR RESTRICTED AREA AND INFORMATION USED FOR ACCESS TO RESTRICTED AREA

(71) Applicant: SUPREMA INC., Seongnam-si (KR)

(72) Inventors: Hyeonchang LEE, Seongnam-si (KR); Hochul SHIN, Seongnam-si (KR); Kideok LEE, Seongnam-si (KR); Jae Won LEE, Seongnam-si (KR); Bong Seop SONG, Seongnam-si (KR)

(73) Assignee: SUPREMA INC., Seongnam-si (KR)

(21) Appl. No.: 14/982,729

(22) Filed: Dec. 29, 2015

(30) Foreign Application Priority Data
Dec. 29, 2014 (KR) 10-2014-0192291

(51) Int. Cl. G07C 9/00

(52) U.S. Cl. CPC G07C 9/00158

(57) ABSTRACT

An authenticating system includes: a biometric information registering device to obtain a first biometric information of a person entering into the area to register the first biometric information with identification information of the person in a database; an biometric authentication device to obtain a second biometric information of the person to authenticate the person based on the first biometric information and the second biometric information; and a biometric information deleting device to obtain a third biometric information of a person leaving the area to delete the first biometric information registered in the database when the first biometric information matches with the third biometric information.

### CROSS-REFERENCE TO RELATED APPLICATION

This application claims priority to Korean Patent Application No. 10-2014-0192291, filed on Dec. 29, 2014, which is incorporated herein in its entirety by reference.

### FIELD

The present disclosure relates to a system and a method for managing an access for a restricted area and information used for the access to the restricted area, and more particularly, to the system and the method for managing the access of a user by using the biometric information.

### BACKGROUND

The statements in this section merely provide background information related to the present disclosure and may not constitute prior art.

At recent, a biometric technology is widely used for a personal authenticating system for security or payment of digital device such as smartphones, as well as for an access control system which has been widely used.

Biometrics authenticates a person by using biometric information which is unique to the person, such as fingerprint, face, iris, and vein recognition. However, it is hard to extract accurate biometric information when obtaining biometric information and extracting characteristics thereof even if biometric information is unique to the person in that the person has biometric information different from others. Therefore, biometric recognition errors may occur in the process of authenticating a person concerned.

In general, exemplary biometric recognition techniques include an 1:1 matching technique to authenticate a specific person based on similarity to the pre-stored biometric information for the specific person, and an 1:N matching technique to authenticate a person based on biometric information satisfied with a similarity condition among biometric information of a plurality of persons.

The aforementioned 1:N matching technique may experience an increasing rate of biometric recognition errors as there are more persons to compare their similarity for their authentication, that is, N becomes greater. In contrast, while the 1:1 matching technique experiences a lower rate of biometric recognition errors, it is necessary to provide a means for notifying a biometric recognition terminal of the identity of the person concerned, for example, an identification card, ID, and personal identification number.

In a typical entrance control system based on biometric recognition, a method for biometric recognition requires a process of registering users with a biometric recognition terminal in which the process of user authentication is performed. In case where the entrance control system is used for access control, and time and attendance management, the number of registered users is generally limited, and user's biometric template information is generally stored. Consequently, the rate of biometric recognition errors becomes relatively low although the 1:N matching technique is employed in the entrance control system.

However, N in the 1:N matching technique may significantly become greater when the entrance control system employs biometric recognition for security, for example, access control, payment, or ID check in a communal area accessed by an unspecified number of users. If the number of users registered for biometric information significantly becomes greater, the increasing number contributes to increasing the rate of biometric recognition errors. This suggests a difficulty in adopting the 1:N technique. In addition, the registered users are concerned about the biometric information of an unspecified number of registered users being stolen. This is why the access control method for using biometric recognition for an unspecified number of users in a communal area is not widely adopted despite its high security level.

### SUMMARY

The present disclosure provides a system and a method for authenticating access to a restricted area in a way of deleting biometric information of a user when the user leaves the restricted area while applying biometric authentication that requires the biometric information to be stored for controlling access to the restricted area.

The challenge of the present disclosure is not limited thereto, but and other challenges that are not described above will be apparent to those skilled in the art from the following description.

In accordance with the present disclosure, there is an authenticating system for a restricted area, using biometric information, and the system includes a biometric information registering device provided at a gate of the restricted area and configured to obtain a first biometric information of a person entering into the restricted area to register the first biometric information with identification information of the person in a database, an biometric authentication device provided in the restricted area and configured to obtain a second biometric information of the person to authenticate the person based on the identification information in the database, the first biometric information and the second biometric information, a biometric information deleting device provided at the gate of the restricted area and configured to obtain a third biometric information of a person leaving the restricted area to delete the first biometric information registered in the database matched with the third biometric information.

In the embodiment, the biometric authentication device may be configured to load the identification information registered in the database corresponding to the first biometric information matched with the second biometric information.

In the embodiment, the biometric information registering device may be configured to register personal information including age information or gender information of the entering person in the database and corresponding to the identification information or the first biometric and the biometric authentication device may be configured to control an access of the person having entered into and not leaving the restricted area depending on the age information or the gender information thereof registered in the database.

In the embodiment, the biometric information registering device and the biometric information deleting device are configured to count numbers of people entering into and leaving the restricted area, respectively, and create information about the numbers of people entering into and people leaving and a number of people remaining in the restricted area.

In accordance with the present disclosure, there is an authenticating method for a restricted area, using biometric information, and the method includes obtaining, at a gate of the restricted area, a first biometric information of a person entering into the restricted area to register the first biometric information with identification information of the person in a database, obtaining, in the restricted area, a second biometric information of the person to authenticate the person based on the identification information in the database, the first biometric information and the second biometric information, obtaining, at the gate of the restricted area, a third biometric information of a person leaving the restricted area to delete the first biometric information registered in the database matched with the third biometric information.

In the embodiment, the obtaining the second biometric information may be configured to load the identification information registered in the database corresponding to the first biometric information matched with the second biometric information.

In the embodiment, the obtaining the first biometric information may be configured to register personal information including age information or gender information of the entering person in the database and corresponding to the identification information or the first biometric information and the obtaining the second biometric information is configured to control an access of the person having entered into and not leaving the restricted area depending on the age information or the gender information thereof registered in the database.

In the embodiment, the obtaining the first biometric information and the obtaining the third biometric information may be further configured to count numbers of people entering into and leaving the restricted area, respectively, and create information about the numbers of people entering into and people leaving and a number of people remaining in the restricted area.

As set forth above, in accordance with the embodiments of the present disclosure, the system and the method significantly lower the possibility of biometric information being stolen by deleting the biometric information of a user when the user leaves a restricted area in spite of applying biometric authentication that requires the biometric information to be stored for controlling access to the restricted area.

In addition, the system and the method lower the rate of biometric recognition errors in spite of employing the 1:1 matching technique.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 shows a configuration of an authenticating system for a restricted area in accordance with an embodiment of the present disclosure; and

FIG. 2 is a flow chart illustrating an authenticating method for a restricted area by using the authenticating system for the restricted area in accordance with an embodiment of the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

The advantages and features of exemplary embodiments of the present disclosure and methods of accomplishing them will be clearly understood from the following description of the embodiments taken in conjunction with the accompanying drawings.

In the following description, well-known functions and/or constitutions will not be described in detail if they would unnecessarily obscure the features of the present disclosure in unnecessary detail. Further, the terms to be described below are defined in consideration of their functions in the embodiments of the present disclosure and may vary depending on a user's or operator's intention or practice. Accordingly, the definition may be made on a basis of the content throughout the specification.

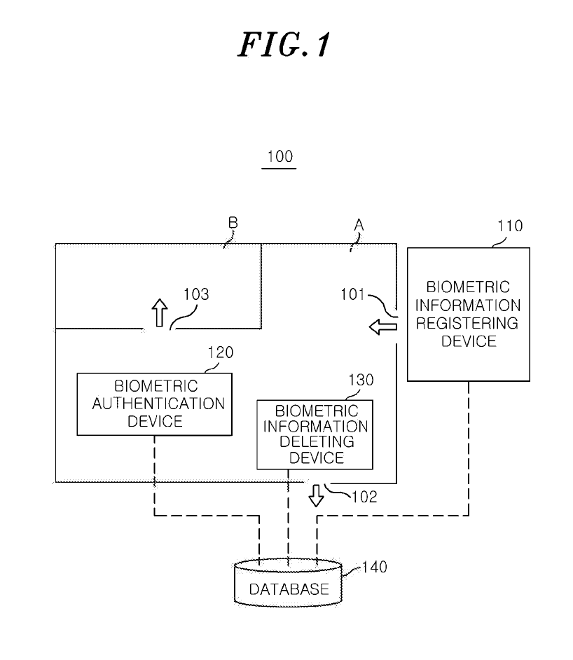

FIG. 1 shows a configuration of an authenticating system for a restricted area in accordance with an embodiment of the present disclosure.

As shown in FIG. 1, an authenticating system 100 for a restricted area in accordance with the embodiment may be implemented in a communal area requiring security. The system 100 may include a biometric information registering device 110 for entrance that may be installed at the entrance (gate) 101 of the restricted area A, an biometric authentication device 120 installed at one or more places in the restricted area A, a biometric information deleting device 130 for exit that may be installed at the exit (gate) 102 of the restricted area A, and a database 140 for storing user identification information and user's biometric information (which may be identified by ‘a first biometric information’ herein) obtained by means of the biometric information registering device 110 for entrance.

The biometric information registering device 110 for entrance obtains and registers a first biometric information of a person who enters into the restricted area A, in which access control is performed by authenticating user authentication based on the first biometric information.

The biometric authentication device 120 may be installed in the restricted area, for example at the entrance 103 of the more restricted area B as a separate compartment in the restricted area A. The device 120 obtains a second biometric information of an entering person, and when the second biometric information matches with the first biometric information, authenticates the user in the area as the person having the identification information based on the first biometric information and the second biometric information.

The biometric authentication device 120 may load the identification information registered in the database 140 corresponding to the first biometric information registered in the database matched with the second biometric information obtained at the biometric authentication device and then carry out the 1:1 matching technique for examining whether the first biometric information matches the second biometric information.

Further, if the biometric information registering device 110 registers personal information including age information or gender information of the entering person in the database 140 and corresponding to the identification information or the biometric information registered in the database 140, then the biometric authentication device 120 may control an access of the person having entered into and not leaving the restricted area, depending on the age information or the gender information thereof registered in the database 140.

The biometric information deleting device 130 for exit may obtain a third biometric information of a person leaving the restricted area A and delete the first biometric information registered in the database 140 matched with the third biometric information.

In this case, the biometric information deleting device 130 for exit and the biometric information registering device 110 for entrance may count numbers of people entering into and leaving the restricted area A, respectively, and the authenticating system 100 may create information about the numbers of people entering into and people leaving the restricted area A and calculate a number of people existing in the restricted area A based on the numbers of people entering into and leaving the restricted area A.

The user identification information uses biometric information obtained by the biometric information registering device 110 for entrance, the internal biometric authentication device 120, or the biometric information deleting device 130 for exit. The biometric information is stored in the database 140. In the embodiment, the stored biometric information may be a biometric template including biometric characteristics. In addition, the identification information may include ID information issued to a user, personal identification number information, age information, and/or gender information.

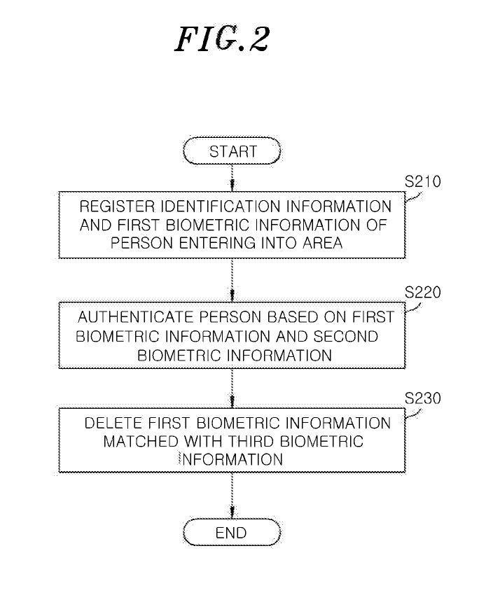

FIG. 2 is a flow chart illustrating an authenticating method for a restricted area by using the authenticating system for the restricted area in accordance with an embodiment of the present disclosure.

As shown in FIG. 2, the authenticating method for a restricted area includes obtaining, at a gate of the restricted area, a first biometric information of a person entering into the restricted area to register the first biometric information with identification information of the person in a database (S210). By the way, the biometric authentication device 120 may be installed at one or more locations of the restricted area.

In addition, the method further includes obtaining, in the restricted area, a second biometric information of a person and when the second biometric information matches with the first biometric information, authenticating the person in the area as the person having the identification information based on the first biometric information and the second biometric information S220. In this case, the biometric authentication device 120 may load the identification information registered in the database corresponding to the first biometric information matched with the second biometric information and then perform the 1:1 matching technique for examining matching with the biometric information obtained from the person entering.

Further, the method further includes obtaining, at the gate of the restricted area, a third biometric information of a person leaving the restricted area to delete the first biometric information registered in the database matched with the third biometric information. In this case, the step of obtaining the first biometric information (S210) and the step of obtaining the third biometric information (S230) are further configured to count numbers of people entering into and leaving the restricted area, respectively, and the method may further include creating information about the numbers of people entering into and people leaving the restricted area A and calculating a number of people existing in the restricted area based on the numbers of people entering into and leaving the area.

With reference to FIGS. 1 and 2, the authenticating method for a restricted area by using the authenticating system for the restricted area is described herein below in more detail.

In the authenticating system 100 for a restricted area, the biometric information registering device 110 for entrance may be installed at the entrance 101 of the restricted area A, and the biometric authentication device 120 may be installed at the entrance 103 of the more restricted area B located in the restricted area A. The biometric information deleting device 130 for exit may be installed at the exit 102 of the restricted area A. In FIG. 1, a case is illustrated that the entrance 103 of the more restricted area B is also used as an exit thereof.

The aforementioned authenticating system 100 for a restricted area may be implemented in a communal area requiring security. For example, the restricted area A may be an airport departure lounge, and the more restricted area B may be a duty-free shop in the departure lounge. Otherwise, the entrance 101 of the restricted area A may be an entrance of an enterprise and the more restricted area B may be a research center in the enterprise.

In the aforementioned authenticating system 100 for a restricted area, the biometric information registering device 110 for entrance obtains biometric information of an entering person when the person attempts to enter the restricted area A through the entrance 101 thereof, and registers the biometric information in the database 140 along with the identification information at operation S210.

In the embodiment, the biometric information may be stored as a biometric template including biometric characteristics. In addition, the biometric information registering device 110 for entrance may issue an ID or personal identification number to an entering person and store the issued ID or personal identification number information as identification information for the person. In this case, the biometric information registering device 110 for entrance may register personal information including age information or gender information of the entering person in the database 140 and corresponding to the biometric information, ID information, and personal identification number information when the personal information is entered. In addition, the identification information and the biometric information to be registered in the database 140 may be achieved when the entering person attempts to enter the restricted area A through the entrance 101 thereof, and alternatively may be registered after obtaining it in advance from a person who attempts to access the restricted area A.

Additionally, if the restricted area A has a plurality of more restricted areas B therein, the biometric information registering device 110 for entrance may give an entering person a security level different from each entering person. For example, different access control scheme may be applied to each person for each of more restricted areas.

Subsequently, when a person in the restricted area A attempts to enter the more restricted area B through the entrance 103, it is necessary that the person is authenticated by the biometric authentication device 120. To do it, the biometric authentication device 120 obtains and compares biometric information of the person with the identification information and the biometric information registered in advance in the database 140. If the matching ratio satisfies an authentication condition as a result of the comparison, the biometric authentication device 120 permits access to the more restricted area B. For example, depending on the embodiment, if the more restricted area B is a duty-free shop in an airport departure lounge, biometric authentication may be performed for buyers who buy duty-free goods.

At the biometric authentication, the biometric authentication device 120 may use both the 1:1 matching technique and the 1:N matching technique for examining matching between the biometric information of the entering person and the biometric information registered in the database 140 in advance. For example, for the 1:1 matching technique, the biometric authentication device receives the identification information from the entering person and loads the biometric information registered in the database 140 corresponding to the received identification information. Matching between the loaded biometric information and the biometric information obtained by obtaining the biometric information of the entering person is examined.

As described above, the biometric authentication device 120 may control access to the more restricted area B depending on the result of biometric authentication by using the identification information and the biometric information registered in advance with database 140. In addition, if the biometric information registering device 110 for entrance has already registered personal information including age information or gender information of the entering person in the database 140 and corresponding to identification information or biometric information of the entering person, the biometric authentication device 120 may load the personal information registered in the database 140 corresponding to the identification information or the biometric information of the person in order to perform access control in conformity with age or gender restrictions by utilizing it. Furthermore, although the biometric information obtained by measuring the biometric information of the entering person matches the biometric information registered in advance, it may be possible to permit access to the more restricted area B, only if the age restriction or the gender restriction is complied with, at operation S220.

Next, if the person in the restricted area A wants to leave the restricted area A through the exit 102, the person provides his/her identification information or biometric information to the biometric information deleting device 130 for exit. That is, the person provides his/her biometric information to the biometric information deleting device 130 for exit, along with the identification information provided to and/or issued from the biometric information registering device 110 for entrance.

Subsequently, the biometric information deleting device 130 for exit deletes the identification information and the biometric information stored in the database 140 corresponding to the person leaving through the exit 102 of the restricted area A. For example, if the identification information has been provided by the person leaving through the exit 102, the biometric authentication device 130 deletes the corresponding biometric information stored along with the same identification information in the database 140, at operation S230.

Meanwhile, the biometric information deleting device 130 for exit may count the number of persons entering and leaving the restricted area A. For example, the biometric authentication device 130 may first count the number of persons entering registered in the database 140 by the biometric information registering device 110 for entrance, and then subtract the number of persons leaving through the exit 102 of the restricted area A from the counted number of persons entering to create information about the number of persons entering and leaving or remaining in the restricted area A. The biometric authentication device 130 may display the created information about the number of persons entering and leaving or remaining on a display screen or process and output it as computer-readable data.

As described above, in accordance with the embodiments of the present disclosure, in spite of applying biometric authentication that requires biometric information for controlling access to a restricted area to be stored, the possibility of biometric information to be stolen is significantly lowered by deleting the biometric information when a user leaves the restricted area. In addition, allowing application of the 1:1 matching technique contributes to lower the rate of biometric recognition errors.

The combinations of respective sequences of a flow diagram attached herein may be carried out by computer program instructions. Since the computer program instructions may be loaded in processors of a general purpose computer, a special purpose computer, or other programmable data processing apparatus, the instructions, carried out by the processor of the computer or other programmable data processing apparatus, create means for performing functions described in the respective sequences of the sequence diagram. Since the computer program instructions, in order to implement functions in specific manner, may be stored in a memory useable or readable by a computer or a computer for other programmable data processing apparatus, the instruction stored in the memory useable or readable by a computer may produce manufacturing items including an instruction means for performing functions described in the respective sequences of the sequence diagram. Since the computer program instructions may be loaded in a computer or other programmable data processing apparatus, instructions, a series of sequences of which is executed in a computer or other programmable data processing apparatus to create processes executed by a computer to operate a computer or other programmable data processing apparatus, may provide operations for executing functions described in the respective sequences of the flow diagram.

Moreover, the respective sequences may indicate some of modules, segments, or codes including at least one executable instruction for executing a specific logical function(s). In some alternative embodiments, it is noted that the functions described in the sequences may run out of order. For example, two consecutive sequences may be substantially executed simultaneously or often in reverse order according to corresponding functions.

The explanation as set forth above is merely described a technical idea of the exemplary embodiments of the present disclosure, and it will be understood by those skilled in the art to which this present disclosure belongs that various changes and modifications may be made without departing from the scope of the essential characteristics of the embodiments of the present disclosure. Therefore, modifications and equivalents that fall within the technical idea of the present disclosure are intended to be embraced by the scope of the present disclosure.

What is claimed is:

1. An authenticating system for an area, using biometric information, the authenticating system comprising:
a biometric information registering device provided at a gate of the area and configured to obtain a first biometric information of a person entering into the area to register the first biometric information with identification information of the person in a database;
an biometric authentication device provided in the area and configured to obtain a second biometric information of a person in the area and, the biometric authentication device configured to authenticate the person in the area as the person having the identification information based on the first biometric information and the second biometric information when the second biometric information matches with the first biometric information; and
a biometric information deleting device provided at the gate of the area and configured to obtain a third biometric information of a person leaving the area to delete the first biometric information registered in the database when the first biometric information matches with the third biometric information.

2. The authenticating system of claim 1, wherein the biometric authentication device is configured to load the identification information registered in the database corresponding to the first biometric information matched with the second biometric information.

3. The authenticating system of claim 1, wherein the biometric information registering device is configured to register personal information including age information or gender information of the entering person in the database, the personal information corresponding to the identification information or the first biometric information, and
wherein the biometric authentication device is configured to control an access of the person having entered into and not leaving the area depending on the age information or the gender information thereof registered in the database.

4. The authenticating system of claim 1, wherein the biometric information registering device and the biometric information deleting device are configured to count numbers of people entering into and leaving the area, respectively, and
wherein the authenticating system is configured to create information about the numbers of people entering into and people leaving the area and calculate a number of people remaining in the area based on the numbers of people entering into and leaving the area.

5. An authenticating method for an area, using biometric information, the authenticating method comprising:
obtaining, at a gate of the area, a first biometric information of a person entering into the area to register the first biometric information with identification information of the person in a database;
obtaining, in the area, a second biometric information of the person to authenticate a person in the area as the person having the identification information in the database, based on the first biometric information and the second biometric information; and
obtaining, at the gate of the area, a third biometric information of a person leaving the area to delete the first biometric information registered in the database when the first biometric information matches with the third biometric information.

6. The authenticating method of claim 5, wherein the obtaining the second biometric information is configured to load the identification information registered in the database, the identification information corresponding to the first biometric information matched with the second biometric information.

7. The authenticating method of claim 5, wherein the obtaining the first biometric information is configured to register personal information including age information or gender information of the entering person in the database, the personal information corresponding to the identification information or the first biometric information, and
wherein the obtaining the second biometric information is configured to control an access of the person having entered into and not leaving the area depending on the age information or the gender information thereof registered in the database.

8. The authenticating method of claim 5, wherein the obtaining the first biometric information and the obtaining the third biometric information are further configured to count numbers of people entering into and leaving the area, respectively, and
wherein the authenticating method is further configured to create information about the numbers of people entering into and people leaving the area and is configured to calculate a number of people remaining in the area based on the numbers of people entering into and leaving the area.
